(19) United States
(12) Patent Application Publication
(10) Pub. No.: US 2026/0236469 A1
(43) Pub. Date: Aug. 13, 2026

(54) METHODS AND PROCESSORS FOR SPECULATIVE QUERY EXECUTION

(71) Applicant: HUAWEI TECHNOLOGIES CO., LTD., Shenzhen (CN)

(72) Inventors: Amir LASHKARI, Kanata (CA); Tom Ching Ling CHEN, Kanata (CA); Robin Dawn GROSMAN, Kanata (CA)

(21) Appl. No.: 19/640,805

(22) Filed: Apr. 7, 2026

Related U.S. Application Data
(63) Continuation of application No. PCT/CN2023/123280, filed on Oct. 7, 2023.

(51) Int. Cl. G06F 16/2453

(52) U.S. Cl. CPC G06F 16/24542; G06F 16/24532

(57) ABSTRACT

Methods and processor for executing a query on a database are disclosed. The method includes acquiring an input batch, acquiring a set of candidate permutations of an execution order assigned with respective current weights where a given weight is indicative of a current probability of selecting the corresponding candidate permutation for processing the input batch. The method includes selecting a first candidate permutation for processing the input batch based on a first current weight, processing the input batch to generate the common output in accordance with first candidate permutation. The method includes, in response to the processing being terminated, generating a first updated weight for the first candidate permutation, the first updated weight being indicative of an updated probability of selecting the first candidate permutation.

### CROSS-REFERENCE

The present application is a continuation of International Patent Application No. PCT/CN2023/123280, with an international filing date of Oct. 7, 2023, entitled “METHODS AND PROCESSORS FOR SPECULATIVE QUERY EXECUTION”, the entirety of which is incorporated herein by reference.

### TECHNICAL FIELD

The present technology relates to database querying, and specifically to methods and processors for speculative query execution.

### BACKGROUND

Database querying allows organized access to large data volumes for processing by a data analytic system. It involves using queries to retrieve specific information from databases. A database query is a request made to a database to retrieve or manipulate data stored in the database. The database query may take form of a command or a set of instructions written in a specific query language designed for interacting with relational databases, for example. Early on, simple commands sufficed, but as data grew, different querying schemes emerged for more complex operations.

A “query plan”, sometimes also referred to as an execution plan, is a detailed outline describing steps that the database management system is configured to perform to execute a specific database query. Data analytic systems may be configured to generative query plans with multiple selective operations. For example, in a 3-way join operation, the data frames can join in different orders, however, the output result will be identical. Selective operations can be executed in different orders, resulting in different execution times which depend on cardinality of the intermediate data. Broadly, an execution time is a duration or a time interval taken by a database system to process and execute a given database operation, while the cardinality of data is a number of distinct values and/or rows in a column and/or table represented by the data.

Some database management systems include a query optimizer, which is a component responsible for analyzing and optimizing database queries to execute them in an efficient manner. Broadly, the query optimizer takes a query as input and determines the best execution plan to retrieve and/or manipulate the requested data.

Traditional query optimizers select an execution order based on a cost model and estimations of cardinality. For example, a cost model can be used by the query optimizer to estimate a cost of executing a specific query plan based on the expected resource usage such as CPU time, disk I/O and/or memory. However, different execution orders can be associated with similar execution costs and/or cardinality estimations can be inaccurate, and therefore the query optimizer may select an inefficient execution order.

Adaptive query execution schemes divide the plan into “subplans” and executes these subplans in stages. When a given stage is completed, actual cardinalities of the intermediate data are used to re-optimize the execution order. However, division and execution of subplans may require additional time. For example, if the intermediate data is indicative of large cardinality during execution of a given subplan, runtime may be delayed until the stage is completed to re-optimize the execution order.

In a first known solution referred to herein as “ScyllaDB” solution, speculative query execution allows to pre-emptively query a second node if a first, current, node takes too much time to respond. If the second node replies faster, its response is sent back to the client, and the first execution by first node is canceled. Different speculative execution policies are available, including constant delay and custom policies. In ScyllaDB, speculative execution does not affect the driver's retry behavior—that is, each parallel execution can trigger retries independently.

In a second known solution referred to herein as “DataStax” solution, speculative query execution allows to pre-emptively start a second execution of a query on a second node to mitigate increased latency caused by a first, slow-responding, node. If the second node replies faster, its response is returned to the client, and the first execution by the first node is cancelled. DataStax provides a configurable delay threshold for sending speculative executions, which can be determined by benchmarking response latencies.

In other knowns solutions disclosed in “Speculative Query Execution in RDBMS Based on Analysis of Query Stream Multigraphs”, authored by Anna Sasak-Okoń and Marek Tudruj, and published in 2020, referred to herein as “Sasak-Okoń and Tudruj” solution, a speculative execution model is provided for queries in relational database management systems. The model analyzes the stream of current queries and creates a multigraph representation of the input query stream. Speculative queries are then selected for parallel execution along with the standard input queries to support faster query execution.

In further known solutions disclosed in Speculative Query Processing, authored by Neoklis Polyzotis and Yannis Ioannidis, and published in 2003, referred to herein as “Polyzotis and Ioannidis” solution, a speculative processing subsystem is proposed and which operates within a visual query interface and takes advantage of the user's think-time in order to issue asynchronous manipulations which prepare the database for the upcoming queries.

Nevertheless, there is a need to ameliorate on known solutions for providing optimal execution plans.

### SUMMARY

Developers have devised methods and devices for overcoming at least some drawbacks present in prior art solutions.

Developers have realized that ScyllaDB and DataStax solutions are designed for a scenario in which a node is taking too much time to respond. These solutions do not revise or adjust the query plan and, instead, the plan is restarted on another node. These solutions lack the ability to adjust the subplans if they are inefficient.

Developers have realized that Sasak-Okoń and Tudruj solutions analyze the queries statistics and adjust the subplans based on the current history of executed queries. These solutions require modeling of queries and also estimation of their statistics which may introduce uncertainty in the selection process.

Developers have realized that Polyzotis and Ioannidis solutions utilize a speculative operation to predict user's future commands and adjust the queries accordingly. However, these solutions are not compatible with systems operating with a full query plan that is divided into subplans.

Developers have realized that in many instances, a query optimizer's ability to identify the optimal plan is limited when relying on modeling and statistical analysis. For example, in scenarios involving complex operations like a 3-way join operation, where sizes of input tables are known but the degree of overlap between them is unknown, the query optimizer may select a sub-optimal query plan.

To address this problem, a query optimizer may attempt to derive indications of potential overlap from histograms or cardinality estimations. Histograms can be used in cases where a significant data skew exists within large value ranges. For example, if table A contains 90% of its data below a constant value x, and table B contains 90% of its data above value x, the overlap between the tables may be at most 10%. However, when data skewness is not significant, a query optimizer may not accurately estimate the degree of overlap. For example, if table A contains odd values and table B contains even values, there is no actual overlap, although statistics might suggest otherwise.

Developers have realized that the inability to accurately estimate overlap between inputs can result in a sub-optimal order of operations, leading to sub-optimal query plans. It should be noted that committing to a sub-optimal ordering of operations may deteriorate the system's overall performance. Furthermore, known methods are ill-suited to adopt a selected plan in response to changes in data statistics. Indeed, once a query plan is committed using known methods, the query plan will be applied to all data batches (e.g., data partitions) without the ability to dynamically adjust as new information becomes available.

It is contemplated that a “data batch” may refer to a group of records processed together by a database management system for computational efficiency, while “data partitioning” may refer to a division of a database table into a set of comparatively smaller segments based on a pre-determined criterion such as range, list or hash partitioning, for example. It is contemplated that a given partition may include and be associated with a plurality of data batches, without departing from the scope of the present technology.

In at least some embodiments of the present technology, there is provided computer-implemented methods and processors for performing batch-wise adaptive query execution. In one implementation, a processor may be configured to execute a query optimizer that generates a query plan comprising a set of permutations of execution orders.

Broadly, “permutations” of execution orders refer to different ways in which operations or steps of a database query can be executed while producing the same output result. It should be noted that although these execution orders may correspond different sequences of operations, the different sequences of operations would yield the same output result.

In some embodiments, during runtime, a processor may be configured to divide input tables into disjoint batches/partitions, allowing independent execution of respective operations with consistent output results across all permutations. It is contemplated that the processor may be configured to adaptively select a most efficient permutation from a provided set of permutations.

In some embodiments, the processor may be configured to assign weights to respective permutations, representing a probability of selecting a given permutation for processing a next batch. It is contemplated that weights may initially be assigned as having equal values and be iteratively updated during the querying process. For example, when a new data batch is acquired, the processor may select a permutation based on current weights of a set of candidate permutations. After the data batch is analyzed, the weight of the selected permutation is updated.

It can be said that the processor may be configured to execute a weight updating mechanism to dynamically adjust probabilities of respective ones from the set of candidate permutations of being selected during processing of a subsequent batch. It should be noted that permutations that perform well across different batches receive increased weights, making them more likely to be selected for processing a subsequent batch. Also, permutations that perform comparatively poorly across different batches receive decreased weights, making them less likely to be selected for processing a subsequent batch.

Developers have realized that by continuously updating weights based on performance of respective candidate permutations, the processor is configured to prioritize more efficient permutations, and thereby enhancing the overall execution strategy. At least some embodiments of the present technology may make use of probabilistic weights to optimize the selection of permutations and improve overall performance of the system over time.

In some embodiments, there is provided computer-implemented methods and processors that can be integrated with a variety database system and/or big data analytics platforms. In some embodiments, the methods and processors disclosed herein may be suitable for implementation in a variety of environments that involve distributed data query analysis for providing flexibility and stability in distributed computing scenarios.

In some embodiments, the query optimizer may determine top-P candidate permutations. Instead of runtime deciding routing, the query optimizer has access to the query plan, and thus may be used to determine candidate execution orders. This may prevent the need to employ a complex routing algorithm during runtime. Additionally, the system may not require additional memory resources for keeping track of data routing when processing a data batch, since top-P candidate permutations represent routes of the batches.

In a first broad aspect of the present technology, there is provided a method of executing a query on a database. The method is executable by a processor communicatively coupled to the database. The method comprises acquiring an input batch. The method comprises acquiring a set of candidate permutations of an execution order, where each of the set of candidate permutations results in a common output if the input batch is processed in accordance with the each of the set of candidate permutations. A first candidate permutation from set of candidate permutations being assigned with a first current weight, and the first current weight is indicative of a current probability of selecting the first candidate permutation for processing the input batch. The method comprises selecting the first candidate permutation for processing the input batch based on the first current weight. The method comprises processing the input batch to generate the common output in accordance with first candidate permutation. The method comprises, in response to the processing being terminated, generating a first updated weight for the first candidate permutation. The first updated weight is indicative of an updated probability of selecting the first candidate permutation. The first updated weight is to be used for the first candidate permutation instead of the first current weight.

In some embodiments of the method, the input batch has a size and the generating the first updated weight is based on the size.

In some embodiments of the method, the input batch is a first input batch. The method further comprises acquiring a second input batch. The method further comprises selecting a second candidate permutation for processing the second input batch based on a second current weight assigned to the second candidate permutation, the second candidate permutation being different from the first candidate permutation. The method further comprises processing the second input batch in accordance with second candidate permutation. The method further comprises in response to the processing of the second input batch being terminated, generating a second updated weight for the second candidate permutation, the second updated weight to be used for the second candidate permutation instead of the second current weight.

In some embodiments of the method, the processing the input batch and the second input batch is performed sequentially.

In some embodiments of the method, the processing the input batch and the second input batch is performed in parallel.

In some embodiments of the method, the input batch and the second input batch are part of a given partition of a database table.

In some embodiments of the method, the input batch is a first input batch. The method further comprises acquiring a third input batch. The method further comprises selecting the first candidate permutation based on the first updated weight for processing the third input batch. The method further comprises processing the third input batch in accordance with the first candidate permutation. The method further comprises in response to the processing the third input batch being terminated, generating a third updated weight for the first candidate, the third updated weight to be used for the first candidate permutation instead of the first updated weight.

In some embodiments of the method, the processing the input batch and the other input batch is performed sequentially.

In some embodiments of the method, the input batch and the third input batch are part of a given partition of a database table.

In some embodiments of the method, the method comprises acquiring a sub-graph of execution permutations for the query and selecting a top-P candidate permutations from the sub-graph as the set of candidate permutations of the execution order.

In a second broad aspect of the present technology, there is provided a processor for executing a query on a database. The processor is communicatively coupled to the database. The processor is configured to acquire an input batch. The processor is configured to acquire a set of candidate permutations of an execution order, where each of the set of candidate permutations results in a common output if the input batch is processed in accordance with the each of the set of candidate permutations. A first candidate permutation from set of candidate permutations is assigned with a first current weight, and the first current weight is indicative of a current probability of selecting the first candidate permutation for processing the input batch. The processor is configured to select the first candidate permutation for processing the input batch based on the first current weight. The processor is configured to process the input batch to generate the common output in accordance with first candidate permutation. The processor is configured to in response to the processing of the input batch being terminated, generate a first updated weight for the first candidate permutation, the first updated weight being indicative of an updated probability of selecting the first candidate permutation, the first updated weight to be used for the first candidate permutation instead of the first current weight.

In some embodiments of the processor, the input batch has a size, the processor is configured to generating the first updated weight based on the size.

In some embodiments of the processor, the input batch is a first input batch. The processor is further configured to acquire a second input batch. The processor is further configured to select a second candidate permutation for processing the second input batch based on a second current weight assigned to the second candidate permutation, the second candidate permutation being different from the first candidate permutation. The processor is further configured to process the second input batch in accordance with second candidate permutation. The processor is further configured to in response to the processing of the second input batch being terminated, generate a second updated weight for the second candidate permutation, the second updated weight to be used for the second candidate permutation instead of the second current weight.

In some embodiments of the processor, the processing the input batch and the second input batch is performed sequentially.

In some embodiments of the processor, the processing the input batch and the second input batch is performed in parallel.

In some embodiments of the processor, the input batch and the second input batch are part of a given partition of a database table.

In some embodiments of the processor, the input batch is a first input batch. The processor is further configured to acquire a third input batch. The processor is further configured to select the first candidate permutation based on the first updated weight for processing the third input batch. The processor is further configured to process the third input batch in accordance with the first candidate permutation. The processor is further configured to in response to the processing the third input batch being terminated, generate a third updated weight for the first candidate, the third updated weight to be used for the first candidate permutation instead of the first updated weight.

In some embodiments of the processor, the processing the input batch and the third input batch is performed sequentially.

In some embodiments of the processor, the input batch and the third input batch are part of a given partition of a database table.

In some embodiments of the processor, the processor is further configured to acquire a sub-graph of execution permutations for the query, and select a top-P candidate permutations from the sub-graph as the set of candidate permutations of the execution order.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein.

FIG. 2 is a schematic illustration of a multipath node executed by the computing device of FIG. 1 and used to process input batches, in accordance with at least some non-limiting embodiments of the present technology.

FIG. 3 is a schematic illustration of a querying process performed by the computing system of FIG. 1, in accordance with at least some non-limiting embodiments of the present technology.

FIG. 4 is a scheme-block diagram of a method executable by the computing device of FIG. 1, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

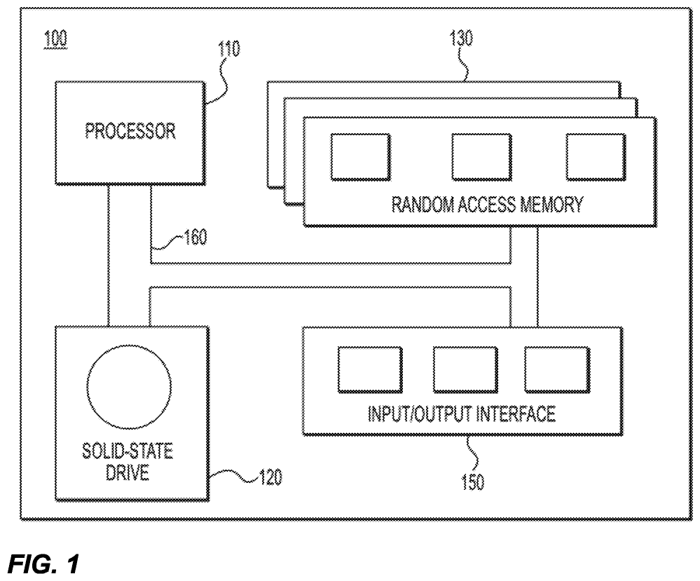

FIG. 1 illustrates a diagram of a computing environment 100 in accordance with an embodiment of the present technology is shown. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random access memory 130 and an input/output interface 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (SaaS). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

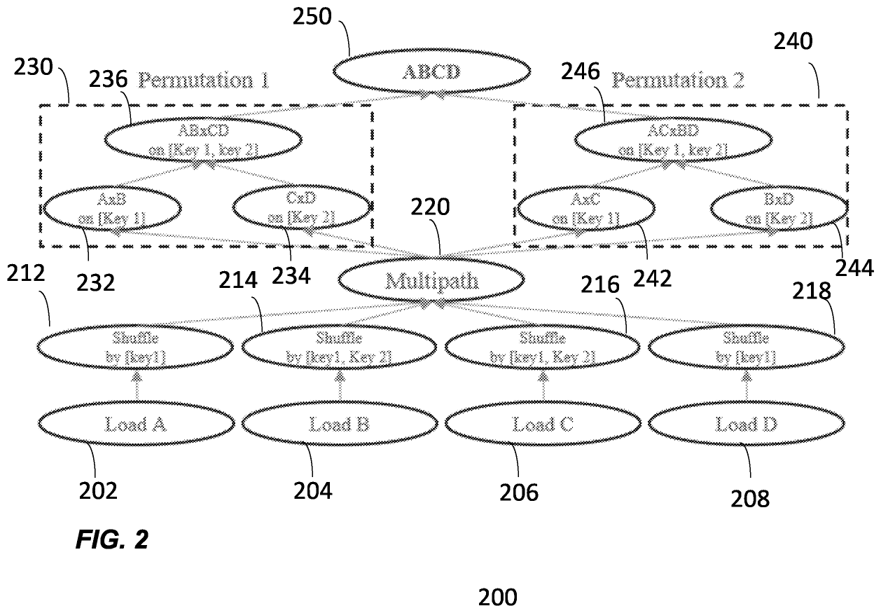

In FIG. 2, there is depicted a non-limiting embodiment of a multipath node 220 configured to process input batches. In this embodiment, the processor 110 may be configured to acquire a first load 202, a second load 204, a third load 206 and a fourth load 208.

It is contemplated that a given one of a plurality of loads acquired by the processor 110 may correspond to a respective data batch to be processed by the multipath node 220. In one implantation, the first load 202, the second load 204, the third load 206 and the fourth load 208 may be represent reading operations on different tables of a database. The first load 202 may represent a read operation on a first table, the second load 204 may represent a read operation on a second table, the third load 206 may represent a read operation on a third table, and the fourth load 208 may represent a reading operation on a fourth table.

The processor 110 is configured to perform one or more shuffle operations on acquire data prior to providing it to the multipath node 220. For example, the processor 110 may perform a shuffle operation 212 on the first load 202, a second shuffle operation 214 on the second load 204, a third shuffle operation 216 on the third load 206, and a fourth shuffle operation 218 on the fourth load 208.

Broadly speaking, a data shuffle operation in the context of the present technology is a computer-implemented mechanism for redistributing and/or re-partitioning data so that the resulting data is grouped differently across different partitions. For example, when data is shuffled by key, it means that the processor 110 is configured to group all data sample(s) with a same/common key in a same/common partition(s).

It should be noted that the processor 110 may use a shuffling operation to redistribute data by keys so the partitions are joined independently and parallel. Developers of the present technology have appreciated that by so-redistributing the data, no communication may be required between partitions with different keys during a join operation.

It is contemplated that a shuffling operation may reduce the execution time of the join operation by processing keys in parallel, while the amount data transfer and computation load remains the same since all data in tables need to be assessed during the operation. Developers of the present technology have appreciated that data transfer and computation load may be divided between nodes since each node will assess a specific key.

In the example illustrated in FIG. 2, during the first shuffle operation 212, the processor 110 shuffles the first load 202 by key 1. In the same example, during the second shuffle operation 214, the processor 110 shuffles the second load 204 by key 1 and key 2. In the same example, during the third shuffle operation 216, the processor 110 shuffles the third load 206 by key 1 and key 2. In the same example, during the fourth shuffle operation 218, the processor 110 shuffles the fourth load 208 by key 1. In some embodiments of the present technology, it can be said that the processor 110 may be configured to perform one or more shuffle operations to group a given load of data into k groups using keys in the given load of data. Once the shuffling operations are executed, shuffled/grouped data is provided to the multipath node 220.

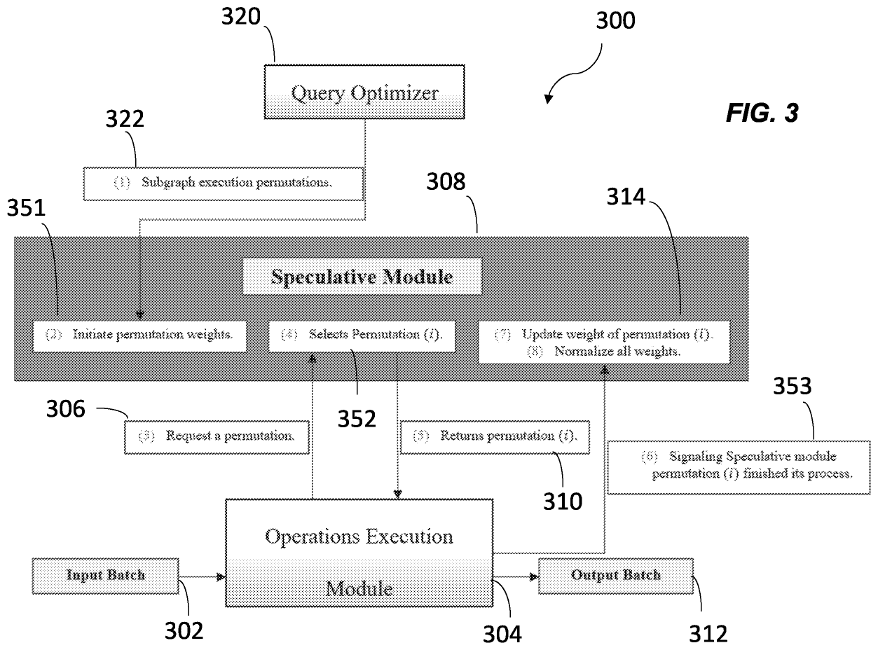

Broadly speaking, in speculative query execution, a “multipath node” represents a state in a query execution plan where a query optimizer (e.g., see query optimizer 320 in FIG. 3) identifies multiple potential execution paths for a given query and is considering executing the query along multiple paths, simultaneously and/or in parallel. As such, the processor 110 may be configured to execute a query using multiple paths, as denoted by the multipath node 220.

In this example, the query may be executed in accordance with a first execution order corresponding to a first permutation 230. In this example, in accordance with the first execution order corresponding to the first permutation 230, first data 232 and second data 234 are joined into joined data 236. In this example, the first data 232 is shuffled data A×B on key 1, the second data 234 is shuffled data C×D on key 2, and the joined data 236 is joined data AB×CD on key 1, key 2.

In the same example, the query may be executed in accordance with a second execution order corresponding to a second permutation 240. In the same example, in accordance with the second execution order corresponding to the second permutation 230, third data 242 and fourth data 244 are joined into joined data 246. In this example, the third data 242 is shuffled data A×C on key 1, the fourth data 244 is shuffled data B×D on key 2, and the joined data 246 is joined data AB×CD on key 1, key 2.

It should be noted that both the first execution order corresponding to the first permutation 230 and the second execution order corresponding to the second permutation 240, result in an output 250 during query execution by the processor 110. It can be said that the processor 110 executing the query in the first execution order and the second execution order results in the same output 250, even though the first execution order and the second execution order correspond to different permutations.

With reference to FIG. 3, there is depicted a querying process 300 performed by the computing environment 100 in at least one non-limiting embodiment of the present technology. It should be noted that the query optimizer 320 provides a sub-graph of execution permutations 322. The query optimizer 320 transmits the sub-graph of execution permutations 322 to a speculative module 308. The sub-graph of execution permutations 322 is indicative of a plurality of potential execution permutations for processing input data.

It can be said that during run-time of the query optimizer 320, the query optimizer 320 may be configured execute one or more tree-like graphs indicative of potential execution permutations for processing input data. It can also be said that the sub-graph of execution permutations 322 may be indicative of a subset of top-P candidate execution permutations to be used by the speculative module 308 during processing of input data.

In some embodiments, during the querying process 300, processor 110 may be configured to initialize the speculative module 308. During initialization, the speculative module 308 may be configured to set equal weights, for example, to the subset of top-P candidate execution permutations. For example, the processor 110 may be configured to determine initial permutations weights 351 during the querying process 300.

During the querying process 300, an operations execution module 304 acquires an input batch 302 of data to be processed. It should be noted that, although the query processing 300 on the input batch 302 is illustrated in FIG. 3, the computing environment 100 may be configured to execute a plurality of querying processes on respective input batches in sequence and/or in parallel to the querying process 300 without departing form the scope of the present technology.

The operations execution module 304 transmits a request 306 to the speculative module 308 for a target permutation to be used for processing the input batch 302. The speculative module 308 is configured to perform a selection process 352 in order to select a given permutation 310 from the subset of top-P candidate execution permutations as the target permutation 310 to be used for processing the input batch 302. Data indicative of the given permutation 310 is then transmitted as the target permutation to the operations execution module 304.

In some embodiments, the speculative module 308 may be configured select any one of the subset of top-P candidate permutations as the target permutation for the input batch 302. It is contemplated that following initialization, each one of the subset of top-P candidate permutations may be assigned with current weights that are equal amongst each other. It can be said that immediately following initialization, any one of the top-P candidate permutations may have a probability of being selected as the target permutation equal to a probability of any other one from the top-P candidate permutations of being selected as the target permutation. It can be said that equal current weights of the top-P candidate permutations are indicative of that each candidate permutation has an equal probability to probabilities of all other candidate permutations of being selected as the target permutation.

Returning to FIG. 3, the operations execution module 304 is configured to generate an output 312 based on at least the input batch 302 and the given permutation 310 (i.e., the target permutation selected by the speculative module 308 for the input batch 302). In some embodiments, the output 312 may be a result of a query and/or input for an other process for which the query is executed. Nevertheless, it should be noted that the output 312 is a same, irrespective of a given permutation provided for execution.

The operations execution module 304 is configured to transmit data 353 to the speculative module 308 for signaling the speculative module 308 of that processing of the given permutation 310 has been terminated. The speculative module 308 may in response generate one or more updated permutation weights 314. The speculative module 308 is configured to update current permutation weights based on the one or more updated permutation weights 314. Additionally, it is contemplated that the speculative module 308 may be configured to normalize all weights based on at least the one or more updated permutation weights 314, without departing from the scope of the present technology.

In some embodiments of the present technology, the query optimizer 320 may generate a query plan for a plurality of multipath nodes, such as the multipath node 220 of FIG. 2, for example, representing one or more sub-graphs indicative of potential permutations of the execution order. It should be noted that all sub-graphs with the multigraph node 220 need to converge to a same final output (to the output 250 in the example of FIG. 3).

It is contemplated that the query optimizer 320 may be configured to employ one or more of cost modeling techniques, cardinality estimation techniques, and statistical data analysis, to prune permutations in one or more sub-graphs, such as the sub-graph of execution permutations 322. During run-time, when the multipath node 220 is encountered, the computing environment 100 may operate in a speculative execution mode for processing remaining portions of the query plan. In the context of the present technology, “pruning” refers to a process of selecting a top-P permutations from the pool of possible permutations. This pruning or selection is executed by a query optimizer through one or more of cost modeling techniques, estimation techniques and actual statistics, as known in the art.

It should be noted that when a given multipath node is encountered, the query optimizer 320 is configured to transmit to the speculative module 308 the sub-graph 322 indicative of at least a subset of candidate permutations of the execution order for the input batch 302. The speculative module 308 is configured to assign weights to respective permutations from the subset of candidate permutations, and which are indicative of a respective probability of selection thereof for processing a given input batch (e.g., partition set). As previously alluded to, the processor 110 may initially assign equal weights to candidate permutations, but which are then dynamically updated based on a processing performance of the operations execution module 304 when employing respective candidate permutations.

It can be said that a current weight assigned to a respective candidate permutation is indicative of a selection probability of the respective candidate permutation for a new input batch and is determined based on inter alia previous performance of the respective candidate permutation on previous input batches. For example, a weight of a given candidate permutation that has a comparatively higher performance to another candidate permutation across a plurality of batches may be more frequently increased (updated), thereby increasing its likelihood of future selection for a future input batch. When a new input batch is acquired by the operations execution module 304, the processor 110 may be configured to select a candidate permutation from the set of candidate permutations based on their respective current weights.

In some embodiments, upon completion of the data batch processing 300, one or more permutation weights may be updated by the speculative module 308. For example, weights may increase or decrease depending on inter alia performance of a respective permutation. Developers of the present technology have realized that the environment 100 may be configured to execute a weight update mechanism allowing for, in a sense, “dynamic tuning” of database querying in cases where the data distribution changes and/or when a given permutation results in sub-optimal performance. By assigning and iteratively updating weights based on performance, the weight update mechanism enables dynamic and efficient selection of candidate permutations for processing subsequent data batches. Developers have realized that designing a query optimizer in combination with a weight update mechanism promotes utilization of more effective permutations.

As mentioned above, in some embodiments, equal weights may be initially assigned to the top-P permutations of the execution order. Following the processing of a data batch (e.g., partition set) using a corresponding execution order, weights Wᵢ associated with the candidate permutations are updated. This weight update process takes into consideration structure of the data batch and resulting outputs of the internal operations.

$${W}_{i} := {W}_{i} ( 1 + α f ( S ) + β g ( R ) ) \qquad ( 1 )$$

where Wᵢ is a weight of permutation i, and Wᵢ: is an updated/assigned weight for permutation i. Wᵢ is updated when the permutation i is selected and the corresponding task is terminated. α and β are hyperparameters allowing for control of an effect of S and R in the weight updating mechanism. More specifically, a is used to control an effect of batch size in the weight updating mechanism, and β controls an effect of size of inner operation outputs in the weight updating mechanism. It is contemplated that values for α and β may be determined by the processor 110 using a grid search algorithm and/or by performing testing on different values. S and R are defined as:

$$S = \frac{Sum of data batch size}{Sum of data batches mean sizes} \qquad ( 2 )$$

$$R = \frac{size of inner operations outputs}{max ( size of inner operations inputs )} \qquad ( 3 )$$

As seen in equation (2), current batch size is taken into consideration by the weight update mechanism. It should be noted that larger batches generally require more time for execution if compared to smaller batches. To remedy this, developers have realized that the size of a current batch may be normalized and used during the weight adjustment process. In some embodiments, a magnitude of a weight adjustment may depend on inter alia a batch size of the input batch.

As seen in equation (3), output size of inner operations is taken into consideration by the weight update mechanism. For instance, in the case of a 3-way join operation, if the output of the inner join has a relatively small size in comparison to its inputs, it indicates an efficient operation with a shorter execution time. In some embodiments, a magnitude of a weight adjustment may depend on inter alia a batch size output size of inner operations.

After updating Wᵢ, weights of all permutations are normalized as follows

$${W}_{j}^{( t + 1 )} = \frac{{W}_{j}^{t}}{{\sum }_{k = 1}^{P} {W}_{k}^{t}} where j = 1 , … , P \qquad ( 4 )$$

In one implementation, the following may be used during the querying process 300: α=0.1, β=0.3, f(S)=S and g(R)=1/(R+ε)−1, where ε is a small floating-point number to avoid division by zero.

In some embodiments of the present technology, there is provided the computing environment 100 configured to perform speculative query execution for a list of partitions at a certain stage of the graph. In these embodiments, pre-shuffling operations may be used for execution of specific tables, particularly when they involve distinct join columns.

In other embodiments of the present technology, there is provided the computing environment 100 for speculative query execution in streaming data analytics systems. In these embodiments, new actors can be introduced with graphs to handle each data partition. Individual branches of the graph can include variations, depending on inter alia specific characteristics of the portioned data. For example, in the context steaming join operations, the computing environment 100 performing speculative query execution may adjust and/or adapt the individual branches dynamically during execution of different windows of the join operations.

In further embodiments of the present technology, the computing environment 100 performing speculative query execution may be employed in the context of a wide range of applications using a distributed environment with multipath subplans or graphs that yield identical outputs. In some embodiments, the computing environment 100 may perform speculative query execution during training and/or inference phases of neural networks, where some operations can be rearranged, and the process typically analyzes batched datasets in a distributed environment.

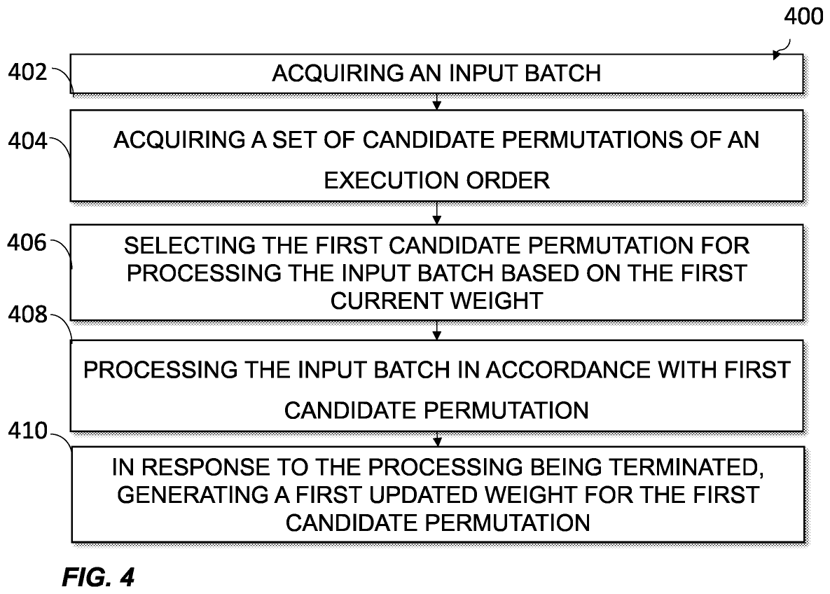

With reference to FIG. 4, there is depicted a scheme-block representation of a method 400 executable by the processor 110 for executing a query on a database. It should be understood that the processor 110 may be configured some, all, and/or additional steps to those illustrated in FIG. 4 as part of the method 400. Steps of the method 400 will now be described in greater details.

### STEP 402: Acquiring an Input Batch

The method 400 begins at step 402 with the processor 110 acquiring an input batch. In one non-limiting example, the processor 110 may be configured to acquire the input batch 302 (see FIG. 3).

In some embodiments, the processor 110 may be configured to acquire a plurality of input batches including the input batch for being processing in parallel and/or sequentially. The plurality of input batches may be part of a single partition of a database table. In one embodiment, one or more shuffling operations may be performed onto the plurality of input batches. The processor 110 may make use of the shuffled data when implementing a multipath node.

### STEP 404: Acquiring a Set of Candidate Permutations of an Execution Order

The method 400 continues to step 404 with the processor 110 configured to acquire a set of candidate permutations of an execution order for the input batch. In some embodiments, the processor 110 may be configured to acquire a sub-graph of execution permutations for the query (e.g., the sub-graph 322 in FIG. 3) and select a top-P candidate permutations from the sub-graph as the set of candidate permutations of the execution order of step 404.

Each of the set of candidate permutations would result in a same/common output if the input batch is processed in accordance with the each of the set of candidate permutations. A first candidate permutation from set of candidate permutations is assigned with a first current weight indicative of a current probability of selecting the first candidate permutation for processing the input batch. In some embodiments of the present technology, the processor 110 may be configured to perform initialization of weights for the respective ones from the set of candidate permutations, as explained above.

### STEP 406: Selecting the First Candidate Permutation for Processing the Input Batch Based on the First Current Weight

The method 400 continues to step 406 with the processor 110 configured to select the first candidate permutation for processing the input batch based on the first current weight. For example, the selection may be performed by the processor 110 while taking into account current weights associated with respective ones from the set of candidate permutations. A given one from the set of candidate permutations may be selected as the first candidate permutation with a likelihood proportional to its current weight.

Developers of the present technology have appreciated that current weights may be employed by the processor 110 for controlling a likelihood of selection of one, or an other candidate permutation, by the processor 110 for processing the input batch.

STEP 408: Processing the Input Batch to Generate the Common Output in Accordance with First Candidate Permutation

The method 400 continues to step 408 with the processor 110 configured to process the input batch. The processing the input batch results in an output that would be the same if any other one from the set of candidate permutations has been used for processing, instead of the first candidate permutation.

Developers of the present technology have appreciated that a performance of a candidate permutation is related to a speed/processing time of the input batch in accordance with that candidate permutation. For instance, if processing in accordance with a first candidate permutation is terminated before processing of an other input batch by a second candidate permutation (the other input batch and the input batch being part of a same partition for example), the corresponding weight of the first candidate permutation will be updated (e.g., increased) before the corresponding weight of the second candidate permutation is updated (e.g., increased). As a result, when processing a further input batch, the likelihood of selecting the first candidate permutation may be greater than the likelihood of selection the second candidate permutation.

STEP 410: In Response to the Processing being Terminated, Generating a First Updated Weight for the First Candidate Permutation

The method 400 continues to step 410 with the processor 110 configured to, in response to the processing of the step 408 being terminated, generate a first updated weight for the first candidate permutation. The first updated weight is indicative of an updated probability of selecting the first candidate permutation. The first updated weight is to be used for the first candidate permutation instead of the first current weight in future selection operations.

In some embodiments, the processor 110 may be configured to generate the first updated wright based on the a size of the input batch.

In at least some embodiments, the processor 110 may be configured to acquire a second input batch (for example, as part of the same query as the input batch). The processor 110 may be configured to select a second candidate permutation for processing the second input batch based on a second current weight assigned to the second candidate permutation. The second candidate permutation can be different from the first candidate permutation. The processor 110 may then process the second input batch in accordance with second candidate permutation. In response to the processing of the second input batch being terminated, the processor 110 may generate a second updated weight for the second candidate permutation. The second updated weight being indicative of an updated probability of selection the second candidate permutation. The second updated weight is to be used by the processor 110 for the second candidate permutation instead of the second current weight during future selection operations. It is contemplated that the processing of the input batch and the second input batch may be performed sequentially and/or in parallel by the processor 110, without departing from the scope of the present technology.

In further embodiments of the present technology, the processor 110 may be configured to acquire a third input batch. For example, the third input batch may be acquired after the generating the first updated weight for the first candidate permutation. The processor 110 may be configured to select the first candidate permutation based on the first updated weight for processing the third input batch. Developers have appreciated that the first candidate permutation is more likely to be selected for the third input batch when assigned with the first updated weight as opposed to when assigned with the previously-current weight. The processor 110 may process the third input batch in accordance with the first candidate permutation. Also, in response to the processing the third input batch being terminated, the processor 110 may generate a third updated weight for the first candidate, and where the third updated weight is to be used for the first candidate permutation instead of the first updated weight.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of executing a query on a database, the method executable by a processor communicatively coupled to the database, the method comprising:
acquiring an input batch;
acquiring a set of candidate permutations of an execution order, each of the set of candidate permutations resulting in a common output if the input batch is processed in accordance with the each of the set of candidate permutations,
a first candidate permutation from set of candidate permutations being assigned with a first current weight, the first current weight being indicative of a current probability of selecting the first candidate permutation for processing the input batch;
selecting the first candidate permutation for processing the input batch based on the first current weight;
processing the input batch to generate the common output in accordance with first candidate permutation; and
in response to the processing being terminated, generating a first updated weight for the first candidate permutation, the first updated weight being indicative of an updated probability of selecting the first candidate permutation, the first updated weight to be used for the first candidate permutation instead of the first current weight.

2. The method of claim 1, wherein the input batch has a size, the generating the first updated weight being based on the size.

3. The method of claim 1, wherein the input batch is a first input batch, the method further comprising:
acquiring a second input batch;
selecting a second candidate permutation for processing the second input batch based on a second current weight assigned to the second candidate permutation, the second candidate permutation being different from the first candidate permutation;
processing the second input batch in accordance with second candidate permutation; and
in response to the processing of the second input batch being terminated, generating a second updated weight for the second candidate permutation, the second updated weight to be used for the second candidate permutation instead of the second current weight.

4. The method of claim 3, wherein the processing the input batch and the second input batch is performed sequentially.

5. The method of claim 3, wherein the processing the input batch and the second input batch is performed in parallel.

6. The method of claim 3, wherein the input batch and the second input batch are part of a given partition of a database table.

7. The method of claim 1, wherein the input batch is a first input batch, the method further comprising:
acquiring a third input batch;
selecting the first candidate permutation based on the first updated weight for processing the third input batch;
processing the third input batch in accordance with the first candidate permutation; and
in response to the processing the third input batch being terminated, generating a third updated weight for the first candidate, the third updated weight to be used for the first candidate permutation instead of the first updated weight.

8. The method of claim 7, wherein the processing the input batch and the other input batch is performed sequentially.

9. The method of claim 7, wherein the input batch and the third input batch are part of a given partition of a database table.

10. The method of claim 1, wherein the method comprises:
acquiring a sub-graph of execution permutations for the query;
selecting a top-P candidate permutations from the sub-graph as the set of candidate permutations of the execution order.

11. A processor for executing a query on a database, the processor communicatively coupled to the database and configured to:
acquire an input batch;
acquire a set of candidate permutations of an execution order, each of the set of candidate permutations resulting in a common output if the input batch is processed in accordance with the each of the set of candidate permutations,
a first candidate permutation from set of candidate permutations being assigned with a first current weight, the first current weight being indicative of a current probability of selecting the first candidate permutation for processing the input batch;
select the first candidate permutation for processing the input batch based on the first current weight;
process the input batch to generate the common output in accordance with first candidate permutation; and
in response to the processing of the input batch being terminated, generate a first updated weight for the first candidate permutation, the first updated weight being indicative of an updated probability of selecting the first candidate permutation, the first updated weight to be used for the first candidate permutation instead of the first current weight.

12. The processor of claim 11, wherein the input batch has a size, the processor being configured to generate the first updated weight based on the size.

13. The processor of claim 11, wherein the input batch is a first input batch, the processor being further configured to:
acquire a second input batch;
select a second candidate permutation for processing the second input batch based on a second current weight assigned to the second candidate permutation, the second candidate permutation being different from the first candidate permutation;
process the second input batch in accordance with second candidate permutation; and
in response to the processing of the second input batch being terminated, generate a second updated weight for the second candidate permutation, the second updated weight to be used for the second candidate permutation instead of the second current weight.

14. The processor of claim 13, wherein the processing the input batch and the second input batch is performed sequentially.

15. The processor of claim 13, wherein the processing the input batch and the second input batch is performed in parallel.

16. The processor of claim 13, wherein the input batch and the second input batch are part of a given partition of a database table.

17. The processor of claim 11, wherein the input batch is a first input batch, the processor is further configured to:
acquire a third input batch;
select the first candidate permutation based on the first updated weight for processing the third input batch;
process the third input batch in accordance with the first candidate permutation; and
in response to the processing the third input batch being terminated, generate a third updated weight for the first candidate, the third updated weight to be used for the first candidate permutation instead of the first updated weight.

18. The processor of claim 17, wherein the processing the input batch and the third input batch is performed sequentially.

19. The processor of claim 17, wherein the input batch and the third input batch are part of a given partition of a database table.

20. The processor of claim 11, wherein the processor is further configured to:
acquire a sub-graph of execution permutations for the query; and
select a top-P candidate permutations from the sub-graph as the set of candidate permutations of the execution order.
